(19) United States
(12) Patent Application Publication
(10) Pub. No.: US 2010/0033704 A1
(43) Pub. Date: Feb. 11, 2010

(54) DEFORMABLE MIRROR, MIRROR APPARATUS, AND EXPOSURE APPARATUS

(76) Inventor: Masayuki SHIRAISHI, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/500,965

(22) Filed: Jul. 10, 2009

Related U.S. Application Data
(60) Provisional application No. 61/136,074, filed on Aug. 11, 2008.

(51) Int. Cl. G03B 27/72; G02B 7/182

(52) U.S. Cl. 355/71; 359/846

(57) ABSTRACT

A mirror apparatus includes a plurality of holes which are divided by partition wall portions on a back surface of a mirror, a plurality of thin film piezoelectric elements which are fixed to bottom surfaces of the plurality of holes respectively, a radiation temperature-regulating plate which has a plurality of projections inserted into the holes, and a mirror control system which individually controls voltages to be applied to the plurality of thin film piezoelectric elements to deform the mirror. The mirror can be efficiently deformed and/or cooled from the side of the back surface without transmitting any vibration to the mirror.

### CROSS-REFERENCES TO RELATED APPLICATIONS

This application claims the benefit of priority of U.S. Provisional Application No. 61/136,074 filed on Aug. 11, 2008, the entire disclosures of which are incorporated herein by reference.

### BACKGROUND OF THE INVENTION

1. Field of the Invention

The present invention relates to a deformable mirror, a mirror apparatus, and an exposure technique and a device-producing technique using the mirror apparatus.

2. Description of the Related Art

For example, when a semiconductor device or the like is produced, an exposure apparatus is used in order that a pattern, which is formed on a reticle (or a photomask or the like), is transferred onto a wafer (or a glass plate or the like) coated with a resist to perform the exposure. Recently, in order to further enhance the resolution, an exposure apparatus (hereinafter referred to as “EUV exposure apparatus”) has been also developed, which employs, as the exposure light (exposure light beam), the extreme ultraviolet light (hereinafter referred to as “EUV light (EUV light beam)”) which has a wavelength of, for example, not more than about 100 nm. In the EUV exposure apparatus, all of the components of the illumination optical system and the projection optical system are constructed of mirrors (catoptric or reflecting optical members), and a reflection type reticle is used for the reticle as well. Further, in order to avoid any absorption of the exposure light by a gas, the mechanism, which includes the illumination optical system and the projection optical system, is arranged in a vacuum chamber.

As for the mirror to be used for the EUV exposure apparatus, a mirror-deforming mechanism, which uses a plurality of actuators, is arranged on the back surface of the mirror in order to change the overall shape and/or the local shape of the mirror so that the image of the pattern to be transferred onto the wafer is adjusted. Those usable as the actuator include voice coil motors and automatically controlled set screws (see, for example, Japanese Patent Application Laid-open No. 2005-4146).

On the other hand, the mirror, which is used in the EUV exposure apparatus, is in a vacuum environment in which the heat is not removed by the convection current. Therefore, it is necessary to perform the cooling via a refrigerant, etc. However, if the cooling mechanism makes direct contact with the mirror, it is feared that the mirror might be vibrated, for example, by the vibration of the piping to induce the vibration of the image. In view of the above, a mirror-cooling apparatus has been developed, wherein a plurality of grooves are provided on the back surface of the mirror; and in each of the grooves, an electronic cooling element is arranged to be opposite to or to face the groove via a spring-shaped member having a high coefficient of thermal conductivity (see, for example, Japanese Patent Application Laid-open No. 2004-39851).

### SUMMARY OF THE INVENTION

The conventional mirror-deforming mechanism uses the actuator which uses, for example, the voice coil motor and/or the set screw, etc. Therefore, the conventional mirror-deforming mechanism is considerably large-sized. Therefore, only a predetermined number of the mirror-deforming mechanisms can be arranged in relation to the size of the deformable mirror.

Further, the surface accuracy, which is required for the mirror of the EUV exposure apparatus, is extremely high as compared with any mirror of a conventional exposure apparatus which uses an exposure light in the far ultraviolet region. Therefore, it is necessary that the surface deformation of the mirror should be corrected finely when the mirror is provided or attached to the exposure apparatus and when the exposure is performed. However, the conventional mirror-deforming mechanism is the large-sized mechanism, and hence it is impossible to arrange, on the back surface of the mirror, the mirror-deforming mechanisms of a number which is larger than a predetermined number; and it has been difficult to finely correct the shape of the surface (surface shape) of the mirror.

On the other hand, as for the cooling apparatus, the heat is principally discharged by the conduction from the back surface of the mirror via the spring-shaped members. Therefore, it is necessary to increase the number of the spring-shaped members in order to enhance the heat discharge efficiency. However, the spring-shaped member has a predetermined rigidity. Therefore, when the number of the spring-shaped members is increased, it is feared that the vibration of the cooling mechanism might be transmitted to the mirror.

The present invention has been made taking the foregoing circumstances into consideration, a first object of which is to provide a deformable mirror and a mirror apparatus wherein it is possible to finely correct a surface shape of a mirror as compared with the conventional technique. A second object of the present invention is to provide a mirror apparatus wherein it is possible to efficiently cool a mirror from a back surface side of the mirror, without transmitting any vibration to the mirror.

According to a first aspect of the present invention, there is provided a deformable mirror comprising partition walls which divide a back surface of the mirror into a plurality of areas; and a plurality of thin film-shaped piezoelectric elements which are fixed to the areas divided by the partition walls respectively.

According to a second aspect of the present invention (first mirror apparatus of the present invention), there is provided a mirror apparatus having a mirror, comprising partition walls which divide a back surface of the mirror into a plurality of areas; a plurality of thin film-shaped piezoelectric elements which are fixed to the areas divided by the partition walls respectively; and a controller which individually controls voltages to be applied to the piezoelectric elements to deform the mirror.

According to a third aspect of the present invention (second mirror apparatus of the present invention), there is provided a mirror apparatus having a mirror, comprising partition walls which divide a back surface of the mirror into a plurality of areas; a heat exchanger which includes a plurality of projections arranged in spaces, surrounded by the partition walls and the areas divided by the partition walls respectively, in a non-contact manner with respect to the partition walls and the areas; and a cooling mechanism which cools the heat exchanger.

According to a fourth aspect of the present invention, there is provided an exposure apparatus which illuminates a pattern with an exposure light and which exposes a substrate with the exposure light come from the pattern, the exposure apparatus comprising a projection optical system which projects, onto the substrate, the exposure light come from the pattern; wherein the projection optical system is provided with the mirror of the present invention.

According to a fifth aspect of the present invention, there is provided an exposure apparatus which illuminates a pattern with an exposure light and which exposes a substrate with the exposure light come from the pattern, the exposure apparatus comprising a projection optical system which projects, onto the substrate, the exposure light come from the pattern; wherein the projection optical system has the first mirror apparatus of the present invention.

According to a sixth aspect of the present invention, there is provided an exposure apparatus which illuminates a pattern with an exposure light and which exposes a substrate with the exposure light come from the pattern, the exposure apparatus comprising a projection optical system which projects, onto the substrate, the exposure light come from the pattern; wherein the projection optical system has the second mirror apparatus of the present invention.

According to a seventh aspect of the present invention, there is provided a method for producing a device, comprising exposing a photosensitive substrate by using the exposure apparatus of the present invention; and processing the exposed photosensitive substrate.

According to the present invention, by providing the thin film-shaped piezoelectric elements in the plurality of areas on the back surface of the mirror, it is possible to finely correct the surface shape of the mirror as compared with any conventional mirror-deforming mechanism.

According to the present invention, by arranging the projections of the heat exchanger in the spaces surrounded by the partition walls and the areas divided by the partition walls, it is possible to cool the mirror efficiently by the radiation.

### BRIEF DESCRIPTION OF THE DRAWINGS

FIG. 1 is a sectional view of a schematic construction of an exemplary exposure apparatus of an embodiment of the present invention.

FIG. 2A shows a back surface of a mirror M1 shown in FIG. 1, and FIG. 2B is a sectional view taken along a line IIB-IIB shown in FIG. 2A.

FIG. 3A is a magnified view illustrating a state that a thickness of a thin film piezoelectric element 41 is shrunk, FIG. 3B shows the stress acting on a hole in the situation shown in FIG. 3A, FIG. 3C is a magnified view illustrating a state that the thin film piezoelectric element 41 is expanded, and FIG. 3D shows the stress acting on the hole in the situation shown in FIG. 3C.

FIG. 4A shows a sectional view illustrating a state that projections of a radiation temperature-regulating plate 36 are inserted into the holes of the back surface of the mirror M1 shown in FIG. 1, and FIG. 4B shows a sectional view taken along a line IVB-IVB shown in FIG. 4A.

FIG. 5 shows main parts or components of a modification of a back surface of a mirror.

FIG. 6 shows a flow chart illustrating exemplary steps of producing a device.

### DESCRIPTION OF THE PREFERRED EMBODIMENTS

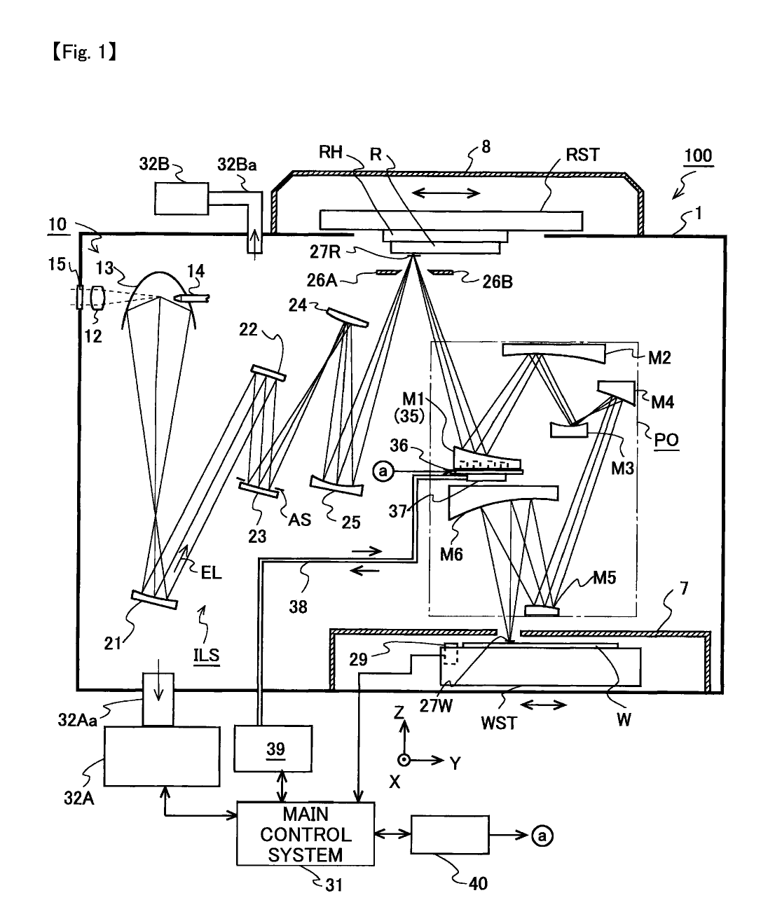

An exemplary embodiment of the present invention will be explained with reference to FIGS. 1 to 4 by way of example.

FIG. 1 is a sectional view schematically illustrating the overall construction of an exposure apparatus (EUV exposure apparatus) 100 of this embodiment which uses, as an exposure light EL (illumination light or illumination light beam), a EUV light (Extreme Ultraviolet Light) (EUV light beam) having a wavelength of not more than 100 nm, for example, 11 nm or 13 nm within a range of, for example, about 3 to 50 nm. With reference to FIG. 1, the exposure apparatus 100 includes a laser plasma light source 10 which generates the exposure light EL, an illumination optical system ILS which illuminates a reticle R (mask) with the exposure light EL, a reticle stage RST which is movable while holding the reticle R, and a projection optical system PO which projects an image of a pattern formed on a pattern surface (reticle surface) of the reticle R onto a wafer W (photosensitive substrate) coated with a resist (photosensitive material). The exposure apparatus 100 further includes, for example, a wafer stage WST which is movable while holding the wafer W, and a main control system 31 which includes a computer integrally controlling the operation of the entire apparatus.

In this embodiment, the EUV light is used as the exposure light EL. Therefore, each of the illumination optical system ILS and the projection optical system PO is constructed of a plurality of mirrors (catoptric optical members), except for specific filters or the like (not shown), and the reticle R is also of the catoptric or reflecting type. Multilayered reflective films, which reflect the EUV light, are formed on the reticle surface and the reflecting surfaces of the mirrors. A circuit pattern is formed by an absorbing layer on the reflective film on the reticle surface. In order to avoid the absorption of the exposure light EL by a gas, the exposure apparatus 100 is accommodated, approximately entirely, in a box-shaped vacuum chamber 1. For example, large-sized vacuum pumps 32A, 32B are provided in order to perform the vacuum evacuation for the space in the vacuum chamber 1 via gas discharge tubes 32Aa, 32Ba, etc. A plurality of subchambers (not shown) are also provided in order to further enhance the degree of vacuum on the optical path for the exposure light EL in the vacuum chamber 1. For example, the vacuum chamber 1 has an internal gas pressure of about 10⁻⁵ Pa, and a subchamber (not shown), which accommodates the projection optical system PO in the vacuum chamber 1, has an internal gas pressure of about 10⁻⁵ to 10⁻⁶ Pa.

In FIG. 1, the following description will be made assuming that the Z axis extends in the normal line direction of the surface (bottom surface of the vacuum chamber 1) on which the wafer stage WST is placed, the X axis extends in a direction perpendicular to the sheet surface of FIG. 1 in a plane perpendicular to the Z axis, and the Y axis extends in a direction in parallel to the sheet surface of FIG. 1. In this embodiment, an illumination area 27R of the exposure light EL on the reticle surface has a circular arc-shaped form which is long in the X direction. During the exposure, the reticle R and the wafer W are synchronously scanned in the Y direction (scanning direction) with respect to the projection optical system PO.

At first, the laser plasma light source 10 is a light source of the gas jet cluster system including a high output laser light source (not shown), a light-collecting lens 12 which collects the laser (laser beam) supplied from the laser light source via a window member 15 of the vacuum chamber 1, a nozzle 14 which jets a target gas of, for example, xenon or krypton, etc., and a light-collecting mirror 13 which has a spheroidal plane-shaped reflecting surface. The exposure light EL radiated from the laser plasma light source 10 is focused or collected on the second focal point of the light-collecting mirror 13. The exposure light EL focused or collected on the second focal point is substantially converted into a parallel light flux via a concave mirror 21, and is guided to an optical integrator constructed of a pair of fly's eye optical systems 22, 23 for uniformizing the illuminance distribution of the exposure light EL. More specified structure and function of the fly's eye optical systems 22, 23 are disclosed, for example, in U.S. Pat. No. 6,452,661; and the disclosure of U.S. Pat. No. 6,452,661 is incorporated herein by reference.

With reference to FIG. 1, a plane, which is in the vicinity of the reflecting surface of the fly's eye optical system 23, is the pupil plane of the illumination optical system ILS. An aperture diaphragm AS is arranged at the pupil plane or at a position in the vicinity of the pupil plane. The aperture diaphragm AS representatively expresses a plurality of aperture diaphragms having apertures of various shapes. By exchanging the aperture diaphragm AS under the control of the main control system 31, it is possible to switch the illumination condition, for example, into the ordinary illumination, the annular illumination, the dipole illumination, or the quadruple illumination, etc.

The exposure light EL, which has passed through the aperture diaphragm AS, is once collected or focused, and then the exposure light EL comes into a curved mirror 24. The exposure light EL reflected by the curved mirror 24 is reflected by a concave mirror 25. After that, the end in the −Y direction of the exposure light EL is shielded by a circular arc-shaped edge portion of a blind plate 26. After that, the exposure light EL illuminates the circular arc-shaped illumination area 27R of the pattern surface of the reticle R obliquely from below at a uniform illuminance distribution. A condenser optical system is constructed by the curved mirror 24 and the concave mirror 25. Owing to the condenser optical system, lights (light beams) come from a large number of reflecting mirror elements constructing the second fly's eye optical system 23 illuminate the illumination area 27R of the reticle surface in a superimposed manner. In the exemplary embodiment shown in FIG. 1, the curved mirror 24 is a convex mirror. However, the curved mirror 24 may be formed of a concave mirror, and the curvature of the concave mirror 25 may be decreased in an amount corresponding thereto. The illumination optical system ILS is constructed to include the concave mirror 21, the fly's eye optical systems 22, 23, the aperture diaphragm AS, the curved mirror 24, and the concave mirror 25. The illumination optical system ILS may be constructed in any manner. For example, in order to further decrease the angle of incidence of the exposure light EL with respect to the reticle surface, a mirror may be arranged, for example, between the concave mirror 25 and the reticle R.

The end in the +Y direction of the exposure light EL reflected by the illumination area 27R of the reticle R is shielded by a circular arc-shaped edge portion of a blind plate 26B, and then the exposure light EL comes into the projection optical system PO. The exposure light EL, which has passed through the projection optical system PO, is projected onto an exposure area 27W on the wafer W (area conjugate with the illumination area 27R). The blind plates 26A, 26B may be arranged, for example, in the vicinity of a conjugate plane conjugate with the reticle surface in the illumination optical system ILS.

On the other hand, the reticle R is attracted and held on the bottom surface of the reticle stage RST via an electrostatic chuck RH. The reticle stage RST is driven by a predetermined stroke in the Y direction by a driving system (not shown) constructed of, for example, a magnetically floating type two-dimensional linear actuator, on a guide surface parallel to the XY plane, of the outer surface of the vacuum chamber 1, based on the measured value obtained by a laser interferometer (not shown) and control information of the main control system 31. Further, the reticle stage RST is also driven in a minute amount, for example, in the X direction and the θZ direction (direction of rotation about the Z axis). A partition 8 is provided to cover the reticle stage RST on the side of the vacuum chamber 1. The interior of the partition 8 is maintained at a gas pressure between the atmospheric pressure and the gas pressure in the vacuum chamber 1 by an unillustrated vacuum pump.

A reticle autofocus system (not shown) of the optical system, which radiates a measuring light (measuring light beam), for example, obliquely onto the reticle surface to measure the position of the reticle surface in the Z direction (Z position), is arranged on the side of the pattern surface of the reticle R. The main control system 31 sets the Z position of the reticle R to be within an allowable range by using, for example, a Z driving mechanism (not shown) included in the reticle stage RST, based on a measured value obtained by the reticle autofocus system during the scanning exposure.

The projection optical system PO is constructed, for example, such that six mirrors M1 to M6 are held by an unillustrated barrel. The projection optical system PO is a catoptric system which is non-telecentric on the side of the object (reticle R) and which is telecentric on the side of the image (wafer W). The projection magnification is a reduction magnification of ¼-fold, etc. The exposure light EL reflected by the illumination area 27R of the reticle R forms, via the projection optical system PO, a reduction image of a part of the pattern of the reticle R in the exposure area 27W on the wafer W. Each of the mirrors constructs a mirror apparatus 70 (70′) including, for example, a driving system thereof as described later on.

In the projection optical system PO, the exposure light EL which comes from the reticle R is reflected by the mirror M1 of the mirror apparatus 70 in the upward direction (+Z direction). Subsequently, the exposure light EL is reflected by the mirror M2 in the downward direction. After that, the exposure light EL is reflected by the mirror M3 in the upward direction, and the exposure light EL is reflected by the mirror M4 in the downward direction. Subsequently, the exposure light EL reflected by the mirror M5 in the upward direction is reflected by the mirror M6 in the downward direction to form the image of the part of the pattern of the reticle R on the wafer W. For example, the mirrors M1, M2, M3, M4, M6 are concave mirrors, and the other mirror M5 is a convex mirror.

On the other hand, the wafer W is attracted and held on the wafer stage WST via an electrostatic chuck (not shown). The wafer stage WST is arranged on a guide surface arranged along the XY plane. The wafer stage WST is driven by predetermined strokes in the X direction and the Y direction by a driving mechanism (not shown) constructed of, for example, a magnetically floating type two-dimensional linear actuator, based on a measured value obtained by a laser interferometer (not shown) and control information of the main control system 31. The wafer stage WST is driven also in the OZ direction, etc., if necessary.

A spatial image-measuring system 29, which detects, for example, an image of an alignment mark of the reticle R, is disposed in the vicinity of the wafer W on the wafer stage WST. A detection result of the spatial image-measuring system 29 is supplied to the main control system 31. The main control system 31 is capable of determining the optical characteristic of the projection optical system PO (for example, the various aberrations or the wave aberration) from the detection result of the spatial image-measuring system 29. As an example, the main control system 31 actively controls the shape (surface shape) of the reflecting surface of the mirror M1 or the like so that the optical characteristic is maintained to be within a predetermined allowable range (details will be described later on). The optical characteristic of the projection optical system PO can be also determined, for example, by a test exposure using a test pattern, i.e., a test print, etc. Further, the deformation of the surface shape of the mirror M1 or the like, which is caused by the radiation heat of the exposure light EL, can be predicted. Therefore, the surface shape of the mirror M1 or the like can be also actively controlled so that the deformation of the surface shape is offset during the exposure.

When the exposure is performed, the wafer W is arranged in a partition 7 so that a gas, which is generated from the resist on the wafer W, does not exert any harmful influence on the mirrors M1 to M6 of the projection optical system PO. An opening, through which the exposure light EL is allowed to pass, is formed in the partition 7. The space in the partition 7 is vacuum evacuated by a vacuum pump (not shown).

When one shot area (die) on the wafer W is exposed, the exposure light EL is radiated onto the illumination area 27R of the reticle R by the illumination optical system ILS, and the reticle R and the wafer W are synchronously moved (subjected to the synchronous scanning), with respect to the projection optical system PO, in the Y direction at a predetermined velocity ratio in accordance with the reduction magnification of the projection optical system PO. In this way, the reticle pattern is exposed onto one shot area on the wafer W. After that, the wafer W is step-moved by driving the wafer stage WST, and then the next shot area on the wafer W is subjected to the scanning exposure with the pattern of the reticle R. In this way, the plurality of shot areas on the wafer W are successively exposed with the image of the pattern of the reticle R in the step-and-scan manner.

Next, an explanation will be made about a mechanism for performing the cooling and the active control of the surface shape of each of the mirrors M1 to M6 of the projection optical system PO of this embodiment. The following description is made about the mechanism (mirror apparatus) in relation to the mirror M1. However, the same or equivalent mechanism (not shown) may be also provided for each of the other mirrors M2 to M6.

The mirror M1 shown in FIG. 1 has a reflecting surface which is provided, for example, such that a surface of a disk-shaped body 35 of the mirror (mirror body 35), which is formed of silica glass, is processed highly accurately into a predetermined concave non-spherical surface, and then a multilayer film composed of molybdenum (Mo) and silicon (Si) is formed on the surface (continuous surface) to provide the reflecting surface. The multilayer film may be a multilayer film obtained by combining a substance including ruthenium (Ru), rhodium (Rh), etc. and a substance including Si, beryllium (Be), carbon tetraboride (B₄C), etc. The surface accuracy of the mirror contributes to the wavefront accuracy about twice. Therefore, the allowable error of the surface accuracy of the reflecting surface is, for example, about 0.1 nm RMS. The back surface of the mirror M1 has a honeycomb structure in which a large number of holes are formed. Elements for deforming the reflecting surface of the mirror M1 are provided in the holes, respectively (details will be described later on).

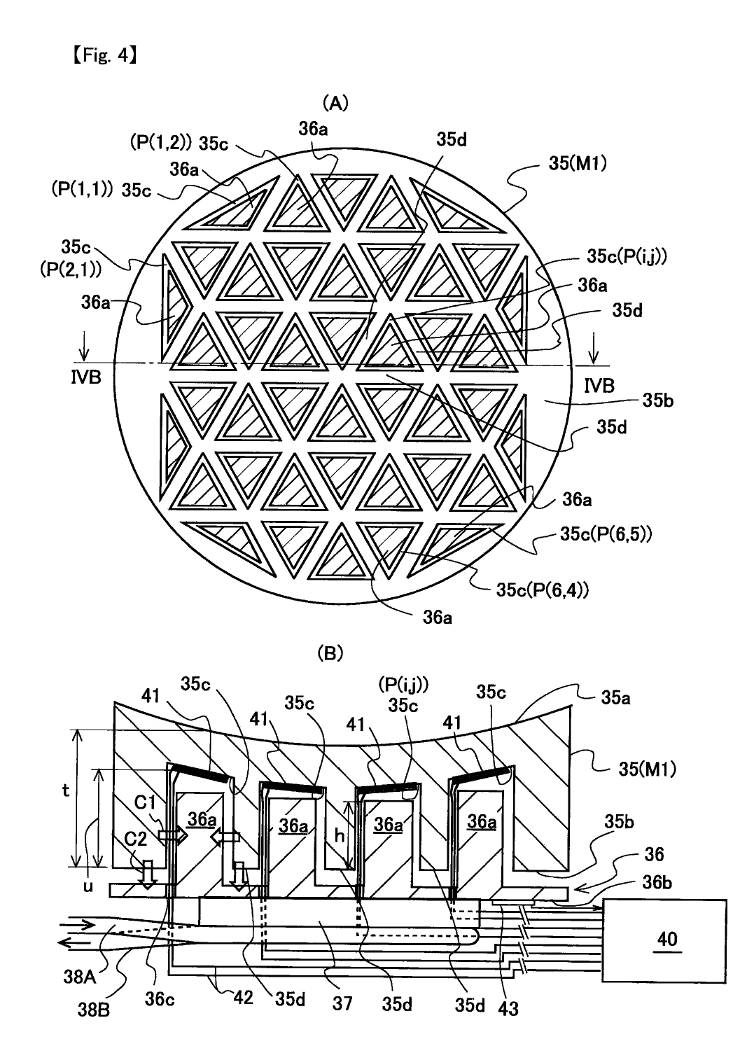

A mirror-driving system 40, which controls the cooling and the deformation of the mirror M1, is connected to the main control system 31. Further, a radiation temperature-regulating plate 36, which receives the heat emitted (radiated) from the mirror M1, is arranged in a non-contact state in the proximity of the back surface of the mirror M1. An electronic cooling element 37 such as a Peltier element or the like, which cools the radiation temperature-regulating plate 36, is arranged on the back surface of the radiation temperature-regulating plate 36 while making tight contact therewith. A piping 38, through which a cooled liquid (refrigerant or cooling medium) is supplied, is arranged so that the piping 38 makes tight contact with the electronic cooling element 37. A refrigerant supply apparatus 39, which supplies and recovers the refrigerant with respect to the piping 38, is installed at the outside of the vacuum chamber 1. In this case, the mirror M1 is held by being supported, for example, at three points via a holder 92 (see FIG. 4) on a barrel 90 (see FIG. 4) of the projection optical system PO. The radiation temperature-regulating plate 36 and the electronic cooling element 37 are supported, for example, by a frame 94 (see FIG. 4) inserted through an opening provided through the side surface of the barrel. That is, the mirror M1 is supported independently from the radiation temperature-regulating plate 36 and the electronic cooling element 37. Further, the operation of the refrigerant supply apparatus 39 is controlled by the main control system 31. The piping 38 is divided into a supply piping 38A which supplies the refrigerant and a recovery piping 38B which recovers the refrigerant (see FIG. 4B). In this case, the electronic cooling element 37, from which the heat is discharged by the refrigerant, does not make any direct contact with the mirror M1. Therefore, the vibration of the piping 38 is not transmitted to the mirror

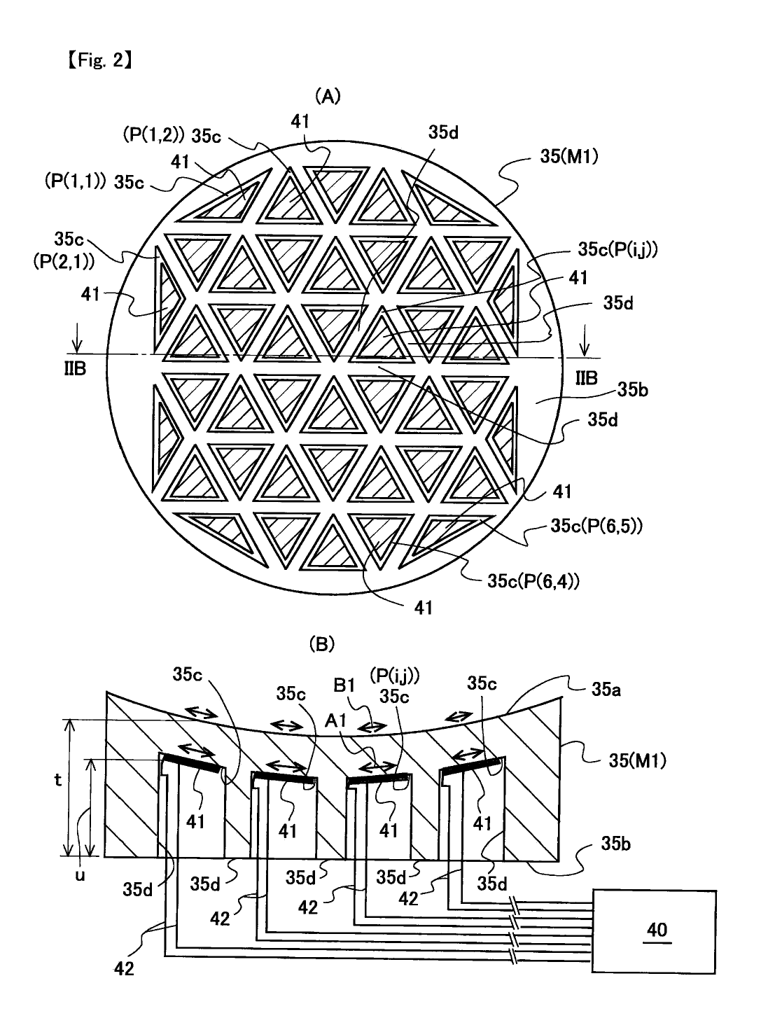

FIG. 2A shows the honeycomb structure provided on the back surface of the mirror M1 shown in FIG. 1, and FIG. 2B shows a sectional view taken along a line IIB-IIB shown in FIG. 2A. In the mirror apparatus 70 shown in FIG. 2A, holes 35c each of which has a predetermined depth, each of which has a triangular cross-sectional shape (shape of the surface perpendicular to the optical axis O of the mirror M1), are formed while being separated from each other by partition wall portions 35d at a large number of positions P (i, j) in the ith column (i=1 to 6 in this embodiment) and the jth row (j=1 to 9 in this embodiment), along two axes substantially perpendicular to one another on the substantially circular back surface 35b of the mirror body 35 constructing the mirror M1. The bottom surface of each of the holes 35c is a flat surface which is substantially parallel to a reflecting surface 35a disposed thereover or thereabove. That is, the bottom surface of the hole 35c also has curvature or inclination (inclination with respect to the optical axis of the mirror) which is same as or equivalent to that of a portion of the reflecting surface 35a opposite to or facing the bottom surface of the hole 35c. The holes 35c, which are disposed at the positions P (1, 1), P (2, 1), etc. in the vicinity of the outer circumference of the back surface 35b, have isosceles triangular shapes; and the holes 35c, which are disposed at other positions P (1, 2), P (6, 4), etc. which are different from the positions P (1, 1), P (2, 1), etc., have regular or equilateral triangular shapes.

By providing the honeycomb structure for the back surface of the mirror M1 as described above, it is possible to realize a light weight and high rigidity of the mirror M1. Further, since the natural frequency of the mirror M1 is increased, the vibration which would be otherwise caused by the resonance is suppressed, and the anti-vibration performance is improved. The shape of the hole 35c may be any arbitrary shape (for example, substantially regular hexagon or square), provided that the rigidity is high and the holes 35c can be arranged at small intervals. The shapes of the holes 35c may differ depending on the positions P (i, j). It is not necessarily indispensable that the holes 35c is provided on the entire back surface of the mirror M1. It is also allowable to provide the holes 35c, for example, only at areas in which the control of the deformation and/or the cooling is required.

As shown in FIG. 2B, the depths of the respective holes 35c are defined so that the spacing distances with respect to the reflecting surface 35a (surface) disposed thereover or thereabove are substantially constant irrelevant to the positions P (i, j). That is, assuming that “t” represents the height from the back surface 35b of the mirror body 35 to the reflecting surface 35a at the center of each of the holes 35c and “u” represents the depth at the center of the hole 35c, the difference (t−u) is approximately constant. When the thickness, of the mirror M1, on the side of the reflecting surface is made constant, then the temperature gradient, which depends on the position of the reflecting surface and which is caused by the radiation heat of the exposure light, is decreased, and the uniformity of the temperature distribution of the mirror M1 after the heat exchange is also improved as described later on; and any complicated thermal deformation of the mirror M1 is suppressed. Further, when the thickness, of the mirror M1, on the side of the reflecting surface is made constant, the difference in the deformation amount of the reflecting surface caused by the stress applied to the hole 35c is decreased as described later on. Therefore, it is easy to control the surface shape.

Thin film piezoelectric elements 41, which have shapes approximately similar to the holes 35c respectively and which are slightly smaller than the holes 35c, are fixed to the bottom surfaces of the large number of the holes 35c, respectively, of the honeycomb structure provided on the back surface of the mirror M1. Each of the thin film piezoelectric elements 41 is prepared such that thin films of a dielectric having large piezoelectricity including, for example, lead titanate zirconate (PZT), are stacked as a predetermined number of layers on the bottom surface of the hole 35c. In FIG. 2A, the thin film piezoelectric elements 41 are fixed to all of the holes 35c of the mirror M1 respectively. However, the thin film piezoelectric elements 41 may be fixed only to a part of the holes 35c (required holes 35c among the holes 35c, for example, holes 35c disposed on the side of the back surface in relation to the areas irradiated with large amounts of the exposure light). Further, the shape of the thin film piezoelectric element 41 is not necessarily similar to that of the hole 35c. The thin film piezoelectric element 41 may be, for example, circular or square.

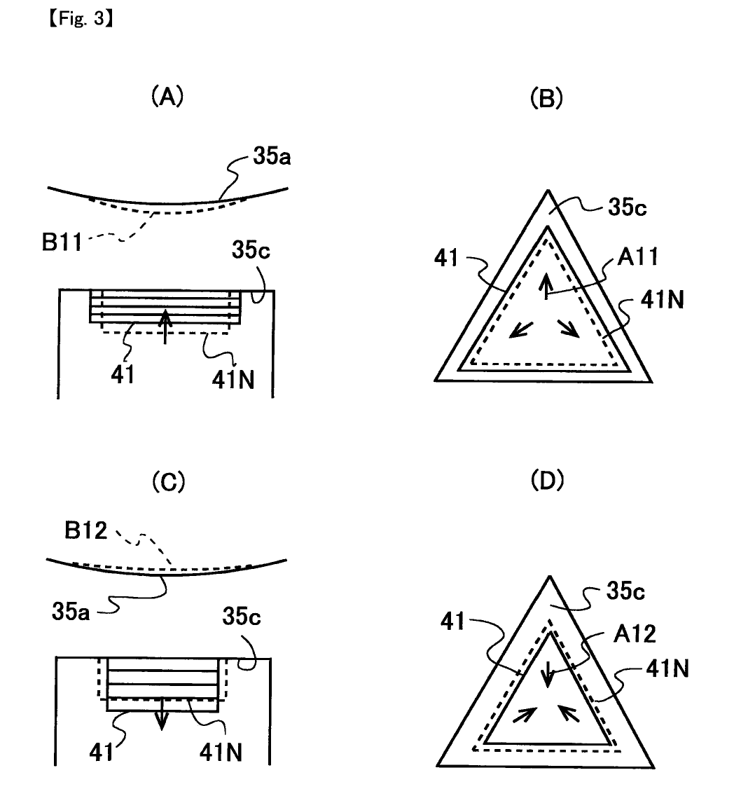

Each of the thin film piezoelectric elements 41 is connected to the mirror-driving system 40 via a pair of lead wires 42. The mirror-driving system 40 individually applies a variable voltage to each of the thin film piezoelectric elements 41 to expand/shrink (contract) each of the thin film piezoelectric elements 41 in a direction perpendicular to the reflecting surface 35a of the mirror M1, to thereby apply the stress to the reflecting surface 35a disposed over or above the thin film piezoelectric element 41. For example, as shown in FIG. 3A, by shrinking the thickness of the thin film piezoelectric element 41 with respect to an intermediate state (state that no voltage is applied) 41N, it is possible to apply the stress, which is directed from the center toward the outside (in directions perpendicular to the thickness of the thin film), to the hole 35c as shown by arrows A11 in FIG. 3B. In accordance with this, as depicted with a curved surface B11 by a dotted line in FIG. 3A, the reflecting surface 35a, which is disposed over or above the thin film piezoelectric element 41, is changed, for example, to be slightly thinner (so that the radius of curvature of the reflecting surface is increased).

On the other hand, as shown in FIG. 3C, by expanding the thin film piezoelectric element 41 in the thickness direction thereof with respect to the intermediate state 41N, it is possible to apply the stress, which is directed from the outside toward the center of the hole 35c, to the reflecting surface 35a as shown by arrows A12 in FIG. 3D. In accordance with this, as depicted with a curved surface B12 by a dotted line in FIG. 3C, the reflecting surface 35a, which is disposed over or above the thin film piezoelectric element 41, is changed, for example, to be slightly thicker (so that the radius of curvature of the reflecting surface is decreased).

Further, as an example, a relationship is previously determined between the voltage of each of the thin film piezoelectric elements 41 (stress at the hole 35c) and the amount of change of the recess/protrusion (stress) of the reflecting surface 35a disposed over or above the thin film piezoelectric element 41. This relationship is stored in a storage section (memory) of the mirror-driving system 40. When an information, which relates to the target shape (recess/protrusion distribution) of the reflecting surface 35a of the mirror M1, is supplied from the main control system 31 to the mirror-driving system 40, then a voltage supply section of the mirror-driving system 40 determines the voltage of each of the thin film piezoelectric elements 41 disposed on the back surface of the mirror M1, based on the target shape, and the determined voltage is applied to each of the thin film piezoelectric elements 41. The active deformation control as described above makes it possible to define the target shape for the shape of the reflecting surface 35a of the mirror M1 with ease. In the structure as described above, it is considered that the partition wall portions 35d, which define the plurality of holes 35c, suppress the influence (crosstalk) exerted by the deformation of certain areas of the reflecting surface 35a corresponding to certain holes 35c, among the plurality of holes 35c, (and the thin film piezoelectric elements 41 accommodated therein), on the deformation of other areas of the reflecting surface 35a corresponding to other holes 35 (and the thin film piezoelectric elements 41 accommodated therein) adjacent to the certain areas.

Next, another embodiment of the mirror apparatus 70 will be explained. FIG. 4A shows a sectional view illustrating a state that a large number of projections of the radiation temperature-regulating plate 36 are inserted into the back surface of the mirror M1 shown in FIG. 1, in the same manner as in the practical use; and FIG. 4B shows a sectional view taken along a line IVB-IVB shown in FIG. 4A. In a mirror apparatus 70′ shown in FIG. 4A, the projections 36a, of which shapes are substantially similar to those of the holes 35c respectively and which have slightly smaller cross-sectional shapes, are inserted into the large number of holes 35c (spaces surrounded by the partition wall portions 35d and the bottom surfaces of the holes 35c) formed at the respective positions P (i, j) on the back surface 35b of the mirror M1 (mirror body 35). That is, the projections 36a are positioned while being separated from the partition wall portions 35d by spacing distances, and the projections 36a do not make contact with the partition wall portions 35d. It is not necessarily indispensable that the cross-sectional shape of the projection 36a is substantially similar to the hole 35c. In principle, it is allowable to adopt any shape provided that the side surface of the projection 36a and the inner surface of the hole 35c (surface of the partition wall portion 35d) are close to one another over the substantially entire surfaces.

As shown in FIG. 4B, the large number of projections 36a are integrally fixed to a disk-shaped base portion 36b. The radiation temperature-regulating plate 36 is constructed by the large number of projections 36a and the base portion 36b arranged closely to the back surface 35b of the mirror M1. The base portion 36b is supported by a frame 94. The mirror M1 is supported by a barrel 90 via a holder 92. The frame 94 does not make contact with the barrel 90. The radiation temperature-regulating plate 36 is formed of, for example, an aluminum alloy which is a material having a high coefficient of thermal conductivity. A high radiation ratio coating film, which is formed of, for example, alumina, is coated on (applied to) the surfaces of the large number of projections 36a and the surface of the base portion 36b disposed on the side of the mirror M1, as the surface (opposite surface) opposite to or facing the mirror M1, of the radiation temperature-regulating plate 36. Therefore, the radiation heat of the mirror M1, which is brought about by the exposure light, is efficiently conducted to the projections 36a and the base portion 36b of the radiation temperature-regulating plate 36 by the heat exchange effected by the radiation. In order to enhance the radiation efficiency, the back surface of the mirror M1 and the opposite surface of the radiation temperature-regulating plate 36 (for example, the surfaces of the projections 36a) may be coated with a ceramics.

In this case, it is preferable that depths “u” at the centers of the holes 35c are not less than ½ of the heights “t” of the corresponding reflecting surface 35a, with respect to the back surface 35b respectively. Accordingly, it is possible to enhance the cooling efficiency of the mirror M1 effected by the radiation. Further, it is preferable that heights “h” (depths) of the portions of the respective projections 36a, of the radiation temperature-regulating plate 36, opposite to the holes 35c are increased as large as possible within a range in which the projections 36a make no contact with the holes 35c and the thin film piezoelectric elements 41. The heights h of the respective projections 36a may be averagely increased as large as possible, and the heights h may be individually optimized so that the temperature distribution of the mirror M1, which is caused by the radiation heat during the exposure, is uniformized as far as possible.

In this embodiment, the thin film piezoelectric elements 41 are fixed to the bottom surfaces of the large number of holes 35c on the back surface of the mirror M1. Therefore, a plurality of openings 36c are formed through the base portion 36b of the radiation temperature-regulating plate 36 in order to allow the lead wires 42 of the thin film piezoelectric elements 41 to pass therethrough. Further, the electronic cooling element 37 is arranged on the back surface of the radiation temperature-regulating plate 36 while making tight contact therewith. A temperature sensor 43 is fixed to the radiation temperature-regulating plate 36, and a measurement signal of the temperature sensor 43 is supplied to the mirror-driving system 40. A temperature-controlling section included in the mirror-driving system 40 determines the temperature of the radiation temperature-regulating plate 36 from the measurement signal of the temperature sensor 43; and the temperature-controlling section cools the radiation temperature-regulating plate 36 via the electronic cooling element 37 so that the temperature is within a preset range.

In the structure of the mirror apparatus 70′, the thin film piezoelectric element 41 is provided in the hole 35c of the mirror M1. Therefore, the radiation, which is directed from the bottom surface of the hole 35c to the projection 36a of the radiation temperature-regulating plate 36, is prohibited to some extent. However, there is no shield between the radiation temperature-regulating plate 36 and the partition wall portion 35d which is the side surface of the hole 35c, and thus the heat exchange can be satisfactorily performed by the radiation. That is, as shown by arrows C1, C2, etc. in FIG. 4B, the radiation heat of the exposure light with respect to the mirror M1 is allowed to flow from the partition wall portion 35d (side surface) and the back surface 35b to the base portion 36b and the projection 36a of the radiation temperature-regulating plate 36. Therefore, the increase in the temperature of the mirror M1 is suppressed. Further, the heat, which is generated at the back surface of the electronic cooling element 37 cooling the radiation temperature-regulating plate 36, is discharged to the outside by the refrigerant flowing through the pipings 38A, 38B.

In this case, as the number of the holes 35c of the back surface of the mirror M1 is greater, the surface area of the side surface (partition wall portion 35d) of the hole 35c becomes larger, wherein the efficiency of the heat exchange effected by the radiation can be remarkably improved. Further, the distance from the side surface of the hole 35c to the surface of the projection 36a of the radiation temperature-regulating plate 36 is shorter than the distance from the reflecting surface 35a of the mirror M1 to the back surface 35b. Therefore, the temperature gradient, which is caused by the flow of the heat in the mirror M1, is decreased. Owing to the effect to increase the heat discharge amount and the effect to decrease the heat discharge distance, the increase in the temperature of the mirror M1 is further suppressed. Further, the radiation temperature-regulating plate 36 and the electronic cooling element 37 are supported by the frame 94 independently in the non-contact manner with respect to the barrel 90 and the holder 92 supporting the mirror M1. Therefore, even when any vibration is generated in the radiation temperature-regulating plate 36 and the electronic cooling element 37, the vibration is prevented from being transmitted to the mirror M1.

As described above, according to this embodiment, the shape of the reflecting surface can be actively controlled efficiently and easily by providing the thin film piezoelectric elements 41 on the bottom surfaces of the large number of holes 35c of the honeycomb structure of the back surface of the mirror M1 arranged in vacuum. Further, the heat exchange is performed for the projections 36a of the radiation temperature-regulating plate 36 by the radiation from the side surfaces (partition wall portions 35d) of the holes 35c of the mirror M1. Therefore, it is possible to simultaneously carry out both of the temperature control and the shape control of the mirror M1 by using the honeycomb structure in the state that the vibration is not transmitted from the piping 38 to the mirror M1.

According to the exposure apparatus 100 of this embodiment, the projection optical system PO has the mirror M1, and the reflecting surface of the mirror M1 is deformed by the apparatus including the mirror-driving system 40 and the thin film piezoelectric elements 41 shown in FIGS. 2A and 2B in order to control the optical characteristic of the projection optical system PO in the exposure apparatus in which the pattern of the reticle R is illuminated with the exposure light EL, and the wafer W is exposed with the exposure light EL via (come from) the pattern and the projection optical system PO. Therefore, when the reflecting surface of the mirror M1 is deformed, for example, due to the deformation caused during the assembling and adjustment or the thermal deformation caused by the radiation heat during the exposure, then the reflecting surface is deformed so that the deformation is offset, and thus the optical characteristic of the projection optical system PO can be maintained highly accurately.

In the exposure apparatus 100, the mirror M1 is cooled by using the apparatus including the electronic cooling element 37 and the radiation temperature-regulating plate 36 shown in FIGS. 4A and 4B. Therefore, the increase in the temperature of the mirror M1, which is caused by the radiation heat of the exposure light, can be suppressed, and hence the optical characteristic of the projection optical system PO can be maintained more highly accurately.

The following modifications can be made for the embodiment described above.

(1) In the embodiment described above, the radiation temperature-regulating plate 36 and the electronic cooling element 37 are provided on the back surface of the mirror M1. However, for example, in a case that the radiation heat of the exposure light is in a small amount, the radiation temperature-regulating plate 36 and the electronic cooling element 37 may be omitted.

In this case, the apparatus which deforms the mirror M1 of the embodiment described above includes the plurality of holes 35c which are provided in the honeycomb structure on the back surface of the mirror M1, the plurality of thin film piezoelectric elements 41 which are fixed to the bottom surfaces of the holes 35c respectively, and the mirror-driving system 40 which individually controls the voltages to be applied to the respective thin film piezoelectric elements 41 in order to deform the reflecting surface of the mirror M1. According to this apparatus, in addition to the light weight and the high rigidity realized for the mirror M1, the distances from the respective thin film piezoelectric elements 41 to the reflecting surface 35 are shorter than the distances which range from the back surface of the mirror M1 to the reflecting surface 35a. Therefore, the mirror M1 can be deformed efficiently and easily from the back surface side in the state that the vibration is not transmitted to the mirror M1. As for the mirror as a single part or unit, it goes without saying that the mirror-driving system 40 may be provided as a part distinct from the mirror M1, for example, in view of the convenience of the production and the sales.

(2) In the embodiment described above, the thin film piezoelectric elements 41 are provided in the holes 35c of the back surface of the mirror M1. However, in a case that the mirror M1 is deformed in a small amount, or in a case that the reflecting surface of the mirror M1 is deformed by any other means (for example, in a case that the reflecting surface of the mirror M1 is deformed by the displacement of a mirror holder), it is also allowable that the thin film piezoelectric elements 41 are not provided in the holes 35c.

In this case, the apparatus which cools the mirror M1 of the embodiment described above includes the radiation temperature-regulating plate 36 which includes the plurality of projections 36a arranged in the non-contact manner in the plurality of holes 35c of the back surface of the mirror M1, and the electronic cooling element 37 which cools the radiation temperature-regulating plate 36. According to this apparatus, it is possible to widen the area of the portion at which the hole 35c of the mirror M1 is opposite to or faces the projection 36a. Therefore, the mirror M1 can be efficiently cooled by the heat exchange effected by the radiation. The cooling apparatus uses the radiation, and hence the cooling apparatus is effective especially when the mirror M1 is arranged in vacuum.

(3) In the embodiment described above, one thin film piezoelectric element 41 is provided in each of the holes 35c of the back surface of the mirror M1. However, a plurality of thin film piezoelectric elements may be fixed to all of the respective holes 35c or to predetermined holes 35c, among the holes 35c, and the voltage may be applied individually to the plurality of thin film piezoelectric elements.

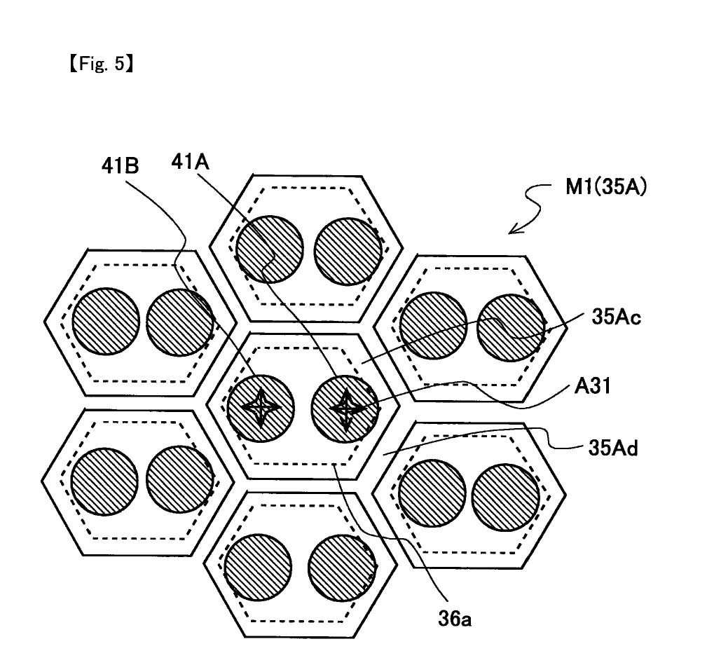

For example, in a modification shown in FIG. 5, a large number of substantially regular hexagonal holes 35Ac are formed while being separated from each other by partition wall portions 35Ad in a honeycomb structure on the back surface of a mirror body 35A constructing a mirror M1. Two circular thin film piezoelectric elements 41A, 41B are fixed to each of the holes 35Ac. Projections 36a of a radiation temperature-regulating plate (not shown) have substantially regular hexagonal cross-sectional shapes as well. Also in this case, for example, the thin film piezoelectric elements 41A, 41B are expanded/shrunk in the radial direction from the center of each of the thin film piezoelectric elements 41A, 41B, as shown by arrows A31, and thereby the reflecting surface corresponding thereto can be deformed while providing a more fine or minute recess/protrusion distribution.

(4) In the embodiment described above, the reflecting surface is deformed by expanding/shrinking the thin film piezoelectric elements 41 provided in the holes 35c of the back surface of the mirror M1. However, instead of this, for example, the deformation of the reflecting surface can be also induced by directly pushing/pulling the bottom surfaces of the holes 35c by expansion/shrinkage elements (for example, piezo-actuators) arranged movably in openings provided in the projections 36a of the radiation temperature-regulating plate 36. In the case of the construction in which the expansion/shrinkage elements are allowed to enter into and retract from the projections 36a, the heat exchange can be performed efficiently without inhibiting the heat exchange between the holes 35c and the projections 36a by the expansion/shrinkage elements.

In the embodiment described above, the mirror constructing the projection optical system of the EUV exposure apparatus has been explained. However, the way of use of the mirror is not limited to the projection optical system of the EUV exposure apparatus. For example, the mirror may be used as a mirror of a single reflecting mirror. Such a mirror is preferably usable for the way of use in the vacuum atmosphere such as the space in the cosmos or the like. The mirror may be incorporated into an observing instruments and a measuring instruments to be used in the atmosphere as described above.

The embodiment described above has been explained for the case in which the EUV light is used as the exposure light, and the all reflection projection optical system constructed of only the six mirrors is used. However, this case is referred to by way of example. The present invention is also applicable, for example, to an exposure apparatus provided with a projection optical system including only four mirrors as disclosed in Japanese Patent Application Laid-open No. 11-345761 as a matter of course, as well as to a projection optical system having four to eight mirrors and using, as a light source, a VUV light source having a wavelength of 100 to 200 nm, including, for example, the Ar₂ laser (wavelength: 126 nm). The present invention is also applicable in a case that a projection optical system of the catadioptric system, which includes a lens at any part thereof, is used to perform, for example, the control of the temperature or the deformation of the mirror arranged in a gas through which the exposure light (for example, ArF excimer laser light beam) is transmissive.

In the embodiment described above, the laser plasma light source is used as the exposure light source. However, there is no limitation to this. It is also allowable to use any one of, for example, the SOR (Synchrotron Orbital Radiation) ring, the betatron light source, the discharged light source, and the X-ray laser, etc.

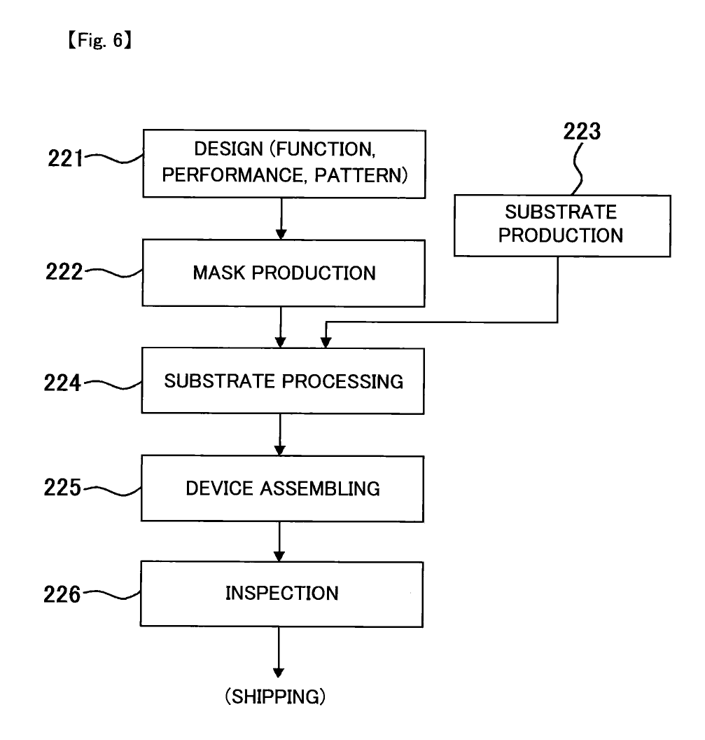

In a case that an electronic device such as a semiconductor device (or a microdevice) is produced by using the exposure apparatus of the embodiment described above, the electronic device is produced by performing, for example, as shown in FIG. 6, a step 221 of designing the function and the performance of the electronic device; a step 222 of manufacturing a mask (reticle) based on the designing step; a step 223 of producing a substrate (wafer) as a base material for the device and coating. the substrate (wafer) with the resist; a substrate-processing step 224 including a step of exposing the substrate (photosensitive substrate) with the pattern of the mask by the exposure apparatus (EUV exposure apparatus) of the embodiment described above, a step of developing the exposed substrate, a step of heating (curing) and etching the developed substrate, etc.; a step 225 of assembling the device (including processing processes such as a dicing step, a bonding step, and a packaging step, etc.); an inspection step 226; and the like. In the exposure step described above, the substrate is subjected to the scanning exposure by synchronously moving the reticle R and the wafer W in the Y direction with respect to the projection optical system PO (exposure light) while forming the long circular arc-shaped illumination area extending in the X direction on the reticle surface by illuminating the reticle with the illumination optical system IL. Since the exposure method using the exposure apparatus is known to those skilled in the art, any detailed explanation therefor is omitted. The term “device” is not limited to the semiconductor device, and encompasses various devices including, for example, liquid crystal substrates which can be produced by using the lithography.

In other words, the method for producing the device includes exposing the substrate (wafer) placed or disposed on the projection surface by using the exposure apparatus of the embodiment described above, and processing the exposed substrate (Step 224). In this procedure, according to the exposure apparatus of the embodiment described above, the high optical characteristic can be maintained. Therefore, the device can be produced highly accurately.

The present invention is not limited to the embodiments described above, and may be embodied in other various forms without deviating from the gist or essential characteristics of the present invention.

According to the mirror, the mirror apparatus, and the exposure apparatus provided with the same of the present invention, the reflecting surface of the mirror can be partially deformed finely without receiving any vibration from the outside. Therefore, it is possible to maintain the satisfactory optical characteristic. Therefore, by using the present invention, it is possible to produce the high performance device at high throughput. Therefore, the present invention will remarkably contribute to the international development of the precision mechanical equipment industry and the optical instrument industry including the semiconductor industry.

1. A deformable mirror comprising:
partition walls which divide a back surface of the mirror into a plurality of areas; and
a plurality of thin film-shaped piezoelectric elements which are fixed to the areas divided by the partition walls respectively.

2. The deformable mirror according to claim 1, further comprising a controller which individually controls voltages to be applied to the piezoelectric elements.

3. The deformable mirror according to claim 1, wherein each of the piezoelectric elements is a multilayer film which is stacked on one of the areas.

4. The deformable mirror according to claim 1, wherein each of the piezoelectric elements is expandable/shrinkable, from a central portion of one of the areas, in a direction perpendicular to a thickness of each of the piezoelectric elements.

5. The deformable mirror according to claim 1, further comprising a heat exchanger which includes a plurality of projections inserted into spaces, surrounded by the partition walls and the areas respectively, in a non-contact manner with respect to the partition walls and the areas.

6. The deformable mirror according to claim 1, wherein the partition walls are defined by a plurality of holes formed on the back surface of the mirror.

7. The deformable mirror according to claim 6, wherein a reflecting surface of the mirror is a curved surface, and the reflecting surface is parallel to bottom surfaces of the holes opposite to the reflection surface.

8. A mirror apparatus having a mirror, comprising:
partition walls which divide a back surface of the mirror into a plurality of areas;
a plurality of thin film-shaped piezoelectric elements which are fixed to the areas divided by the partition walls respectively; and
a controller which individually controls voltages to be applied to the piezoelectric elements to deform the mirror.

9. The mirror apparatus according to claim 8, wherein each of the piezoelectric elements is a multilayer film which is stacked on one of the areas.

10. The mirror apparatus according to claim 8, wherein each of the piezoelectric elements is expandable/shrinkable, from a central portion of one of the areas, in a direction perpendicular to a thickness of each of the piezoelectric elements.

11. The mirror apparatus according to claim 8, further comprising a heat exchanger which includes a plurality of projections arranged in spaces, surrounded by the partition walls and the areas respectively, in a non-contact manner with respect to the partition walls and the areas.

12. A mirror apparatus having a mirror, comprising:
partition walls which divide a back surface of the mirror into a plurality of areas;
a heat exchanger which includes a plurality of projections arranged in spaces, surrounded by the partition walls and the areas divided by the partition walls respectively, in a non-contact manner with respect to the partition walls and the areas; and
a cooling mechanism which cools the heat exchanger.

13. The mirror apparatus according to claim 12, wherein the cooling mechanism includes a heat-absorbing element which cools the heat exchanger, and a refrigerant supply device which supplies a refrigerant to surroundings of the heat-absorbing element.

14. The mirror apparatus according to claim 12, further comprising:
a plurality of thin film-shaped piezoelectric elements which are fixed to the areas respectively; and
a controller which individually controls voltages to be applied to the piezoelectric elements to deform the mirror.

15. An exposure apparatus which illuminates a pattern with an exposure light and which exposes a substrate with the exposure light come from the pattern, the exposure apparatus comprising:
a projection optical system which projects, onto the substrate, the exposure light come from the pattern;
wherein the projection optical system has the mirror as defined in claim 1.

16. An exposure apparatus which illuminates a pattern with an exposure light and which exposes a substrate with the exposure light come from the pattern, the exposure apparatus comprising:
a projection optical system which projects, onto the substrate, the exposure light come from the pattern;
wherein the projection optical system has the mirror apparatus as defined in claim 8.

17. An exposure apparatus which illuminates a pattern with an exposure light and which exposes a substrate with the exposure light come from the pattern, the exposure apparatus comprising:
a projection optical system which projects, onto the substrate, the exposure light come from the pattern;
wherein the projection optical system has the mirror apparatus as defined in claim 12.

18. The exposure apparatus according to claim 17, wherein the heat exchanger and the cooling mechanism are supported independently from the mirror.

19. The exposure apparatus according to claim 15, wherein the exposure light is a EUV light, and the mirror is arranged in a vacuum atmosphere.

20. A method for producing a device, comprising:
exposing a photosensitive substrate by using the exposure apparatus as defined in claim 15; and
processing the exposed photosensitive substrate.
